(19) United States
(12) Patent Application Publication
(10) Pub. No.: US 2022/0134264 A1
(43) Pub. Date: May 5, 2022

(54) Water Recirculating System for Power Sluices

(71) Applicant: Steven William Bertrand, Las Vegas, NV (US)

(72) Inventor: Steven William Bertrand, Las Vegas, NV (US)

(21) Appl. No.: 17/519,422

(22) Filed: Nov. 4, 2021

Related U.S. Application Data
(60) Provisional application No. 63/110,043, filed on Nov. 5, 2020.

(51) Int. Cl. B01D 29/56; C02F 1/00; B01D 29/05

(52) U.S. Cl. CPC B01D 29/56; C02F 1/001; C02F 2103/10; C02F 2301/046; B01D 29/05

(57) ABSTRACT

A water recirculating system for power sluices includes a first filtration unit, a second filtration unit, and a third filtration unit. Each filtration unit is equipped with a debris catcher and a filter that to clean the dirty water that discharges from the power sluices. A tailings catcher is integrated into the first filtration unit to receives the dirty water that discharges from the power sluices as the first stage of filtration. Then, the debris catchers and the filters clean the dirty water as the first filtration unit is in fluid communication with the second filtration unit, and the second filtration unit is in fluid communication with the third filtration unit. Resulting clean water that enters into the third filtration unit is then pumped back into the power sluices thus allowing a quantity of water to recirculate through the power sluices.

The current application claims a priority to the U.S. Provisional Patent application Ser. No. 63/110,043 filed on Nov. 5, 2020.

### FIELD OF THE INVENTION

The present invention relates generally to tools for precious metals prospecting. More specifically, the present invention is a system for recirculating water for power sluices. The present invention is specifically designed for gold prospecting. However, the present invention is not limited to this option, and it may further be adapted for different purposes.

### BACKGROUND OF THE INVENTION

Throughout history, prospectors seeking gold, silver, and gemstones have generally labored with a pick, shovel, and gold pan to sift through large quantities of unwanted dirt and gravel material to uncover the sought after precious metals that can take the form of miniscule flakes. A shovel load of dirt and gravel is dumped into the gold pan, which is then typically submerged in a river or stream and agitated or panned to allow the heavier materials to sink to the bottom of the pan. The precious metal material, being heavier than the dirt and gravel, is recovered as the material finally remaining at the bottom of the pan. Over time, the gold sinks deep into cracks and crevices in bedrock or other dense material, and many rich deposits have been left high and dry as the result of changes in the position of river and stream channels during the past 100 years or more. The sluice box was developed to better work these rich deposits that now lie outside river and stream beds. Early sluice boxes were wooden structures having a bottom lined with horizontal wooden planks known as riffles. When the sluice box is positioned in a river or stream, the riffles act like boulders in a stream to collect, behind them, the heavier material that is shoveled into the sluice box while allowing the lighter material to wash through the sluice box.

A power sluice, sometimes called a “highbanker” or “hibanker”, is a piece of gold prospecting equipment that uses a pump to force water through a sluice box to mimic the natural flow of a river. However, the existing power sluices usually consume a significant amount of water, increasing the cost for gold prospecting. The present invention aims to solve the problem by disclosing a water recirculating system for power sluices.

It is an objective of the present invention to utilize a reservoir system to continuously recirculate a quantity of water through the power sluice as the quantity of water is cleaned via the present invention. As a result, the present invention is able to minimize water usage for the power sluice. Furthermore, the present invention provides a portable system that can be easily and quickly set up by a single user. Furthermore, the present invention can be easily assembled for use and disassembled for storage or transportation as the present invention easily fits within a typical residential vehicle such as car and SUV.

### BRIEF DESCRIPTION OF THE DRAWINGS

FIG. 1 is a top perspective view of the present invention, wherein the present invention is utilized the power sluices.

FIG. 2 is a top view of the present invention, wherein the present invention is utilized the power sluices.

FIG. 3 is a top perspective view of the present invention.

FIG. 4 is a side view of the first filtration unit of the present invention, wherein the dash lines illustrate the hidden components within the first reservoir.

FIG. 5 is a side view of the second filtration unit of the present invention, wherein the dash lines illustrate the hidden components within the second reservoir.

FIG. 6 is a side view of the third filtration unit of the present invention, wherein the dash lines illustrate the hidden components within the third reservoir.

### DETAIL DESCRIPTIONS OF THE INVENTION

All illustrations of the drawings are for the purpose of describing selected versions of the present invention and are not intended to limit the scope of the present invention.

The present invention is a water recirculating system for power sluices. The present invention is configured with multiple filtration compartments so that the dirty water from the power sluice can sequentially flow into the multiple filtration compartments for purification. Then, the submersible pump that is placed a last compartment of the multiple filtration compartments is able to pump back the clean water into the power sluice. It is an aim of the present invention to reduce the amount of clean water needed for gold prospecting. It is another aim of the present invention to provide a system that can efficiently filter the dirty water used in gold prospecting. It is yet another aim of the present invention to provide a water recirculating system that can be easily transported, stored, assembled, and disassembled. It is yet another purpose of the present invention to operate the power sluices where water is not available and the user has to bring their own water, such as a desert. It is yet another purpose to allow the user to run the power sluice at home in a garage or yard, for those who choose to bring material home to run for various reasons, mostly due to extreme weather, extremely hot or extremely cold.

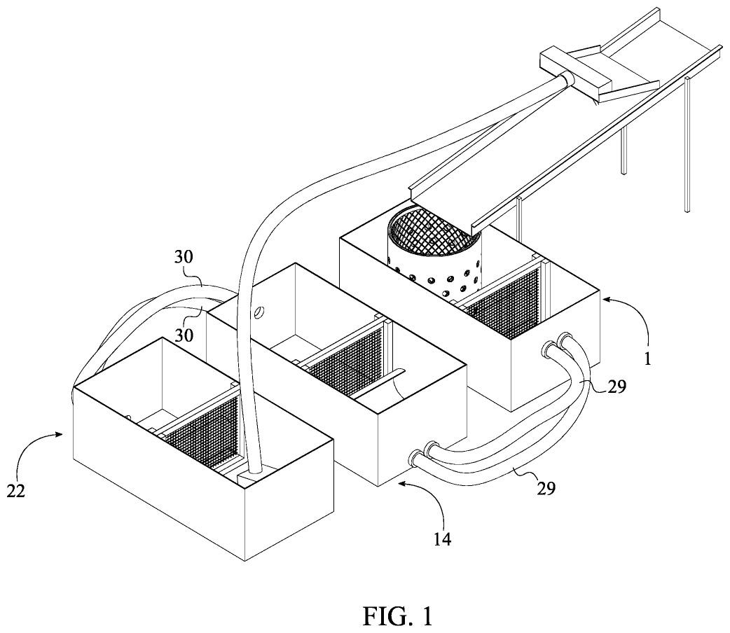

As shown in FIGS. 1-3, the present invention may comprise a first filtration unit 1, a second filtration unit 14, and a third filtration unit 22. In reference to general configuration of the present invention, the first filtration unit 1, the second filtration unit 14, and the third filtration unit 22 are in fluid communication with each other so that the dirty water from the power sluices can be sequentially channeled through the first filtration unit 1, the second filtration unit 14, and the third filtration unit 22 for purification. The submersible pump is then utilized within the third filtration unit 22 to recycle the clean water back into the power sluices. The power sluices and the submersible pump are industry standard equipment that are well known within the gold prospecting field.

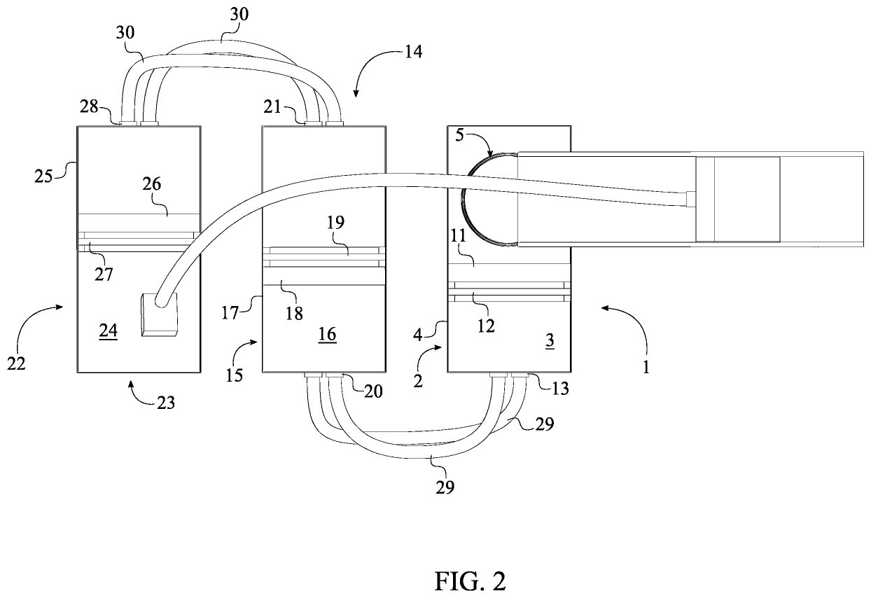

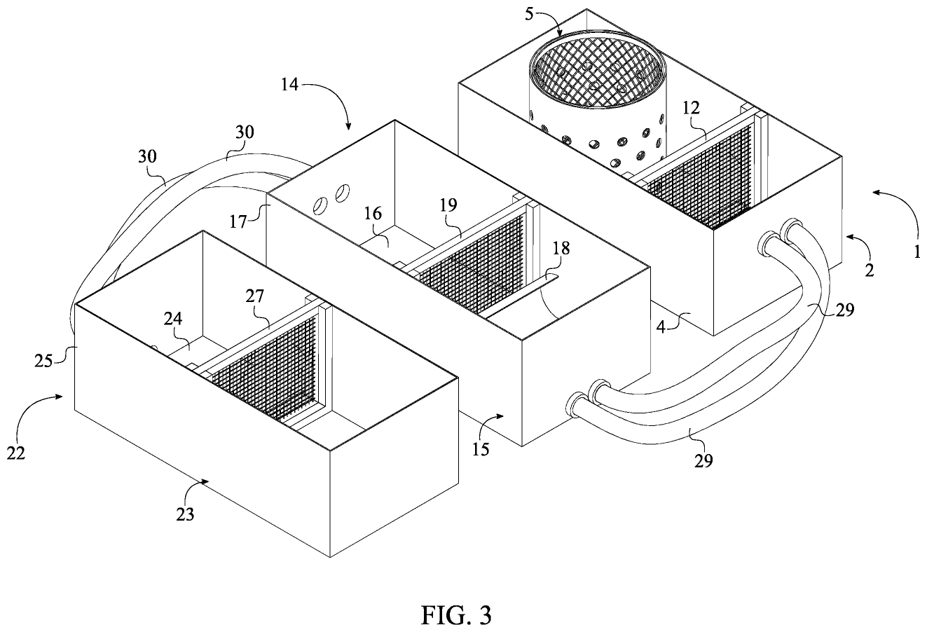

In reference to FIGS. 2-3, the first filtration unit 1 may comprise a first reservoir 2, a tailings catcher 5, a first debris catcher 11, and a first filter 12. The second filtration unit 14 may comprise a second reservoir 15, a second debris catcher 18, and a second filter 19. The third filtration unit 22 may comprise a third reservoir 23, a third debris catcher 26, and a third filter 27. More specifically, the tailings catcher 5, the first debris catcher 11, and the first filter 12 are integrated within the first reservoir 2 so that the first filtration unit 1 can complete a first stage of filtration within the present invention. The second debris catcher 18 and the second filter 19 are integrated within the second reservoir 15 so that the second filtration unit 14 can complete a second stage of filtration within the present invention. The third debris catcher 26 and the third filter 27 are integrated within the third reservoir 23 so that the third filtration unit 22 can complete a third stage of filtration within the present invention. The first reservoir 2 is in fluid communication with the second reservoir 15 thus allowing the dirty water from the power sluices to complete the first stage of filtration. The second reservoir 15 is in fluid communication with the third reservoir 23 thus allowing the partially clean water from the first stage of filtration to complete the second stage of filtration. Then, the almost clean water from the second stage of filtration can be filtered into clean water via the third stage of filtration as the submersible pump recycle back the clean water into the power sluices.

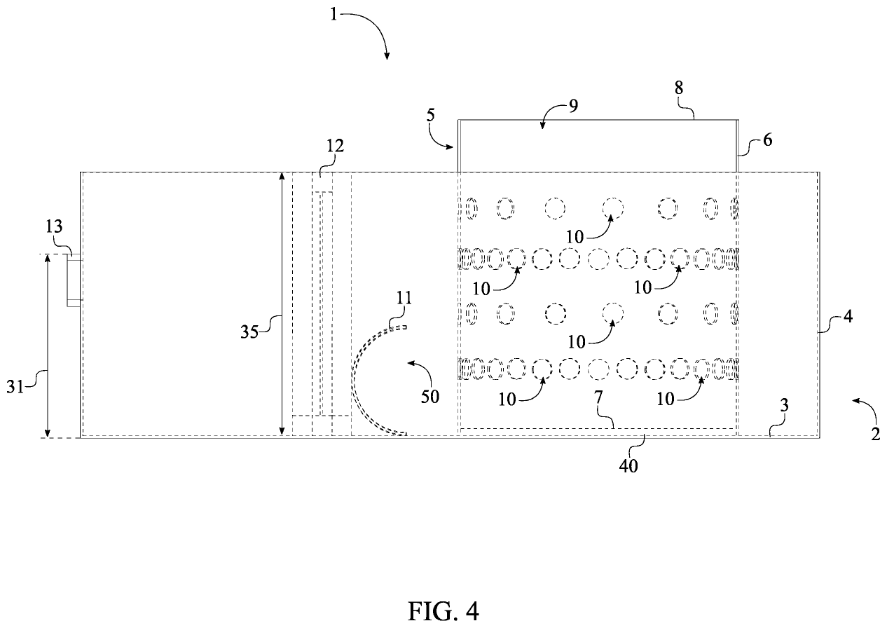

In reference to FIG. 4, the first filtration unit 1 may further comprise at least one first outlet 13 in addition to the tailings catcher 5, the first debris catcher 11, and the first filter 12. The tailings catcher 5 is positioned atop a base 3 of the first reservoir 2 to remove large debris, also known as tailings within the mining industry, that is discharged from the power sluices. The tailings catcher 5 may comprise a tubular body 6, a base panel 50, a main opening 9, and a plurality of openings 10. More specifically, a bottom edge 7 of the tubular body 6 is perimetrically connected to the base panel 50. Resultantly, the base panel 50 is positioned atop the base 3 of the first reservoir 2 so that the tubular body 6 can oriented upright within the first reservoir 2. The main opening 9 is delineated by a top edge 8 of the tubular body 6 as the main opening 9 is oppositely positioned from the base 3 of the first reservoir 2 about the tubular body 6. As a result, the dirty water from the power sluices can enter into the present invention via the main opening 9. The plurality of openings 10 radially traverses through the tubular body 6 so that the dirty water from the power sluices can be drained through the plurality of opening while large debris get trapped within the tubular body 6. Preferably, the tubular body 6 is formed into a cylindrical shape. Additionally, a mesh basket may be configured within the tailings catcher 5 to facilitate further filtration. Due to the removable positioning of the tailing catcher 5, the user can intermittingly remove the tailings catcher 5 from the first reservoir 2 to unload the trapped tailings.

The first outlet 13 is connected to a lateral wall 4 of the first reservoir 2 so that an inlet end of a first hose 29 can be attached to the first reservoir 2. As shown in FIG. 4, the first outlet 13 is positioned offset from the base 3 of the first reservoir 2 in such a way that the tailings catcher 5 and the first outlet 13 are oppositely positioned of each other within the first reservoir 2. The first filter 12 is removably mounted to the base 3 and the lateral wall 4 of the first reservoir 2, wherein the first filter 12 is positioned in between the tailings catcher 5 and the first outlet 13. The first debris catcher 11 is terminally connected onto the base 3 and the lateral wall 4 of the first reservoir 2, wherein the first debris catcher 11 is positioned in between the tailings catcher 5 and the first filter 12. When the dirty water is discharged from the tailings catcher 5 and flows toward the first outlet 13, the first debris catcher 11 is able to trap remaining heavy particles that sink toward the base 3 of the first reservoir 2. Furthermore, an opened end 50 of the first debris catcher 11 is oriented toward the tailings catcher 5 to maximize the surface area that comes into contact with the dirty water. The dirty water is then cleaned through the first filter 12 before entering into the first outlet 13 as the partially clean water. As shown in FIG. 4, a first height 31 is defined between the base 3 of the first reservoir 2 to the first outlet 13 as the first reservoir 2 is configured to maintain a specific water level. In other words, the water level within the first reservoir 2 is determined by the first height 31. In order to provide proper filtration, a height 35 of the first filter 12 has to be larger than the first height 31 so that dirty water that flows through the first reservoir 2 is able to fully penetrate through the first filter 12.

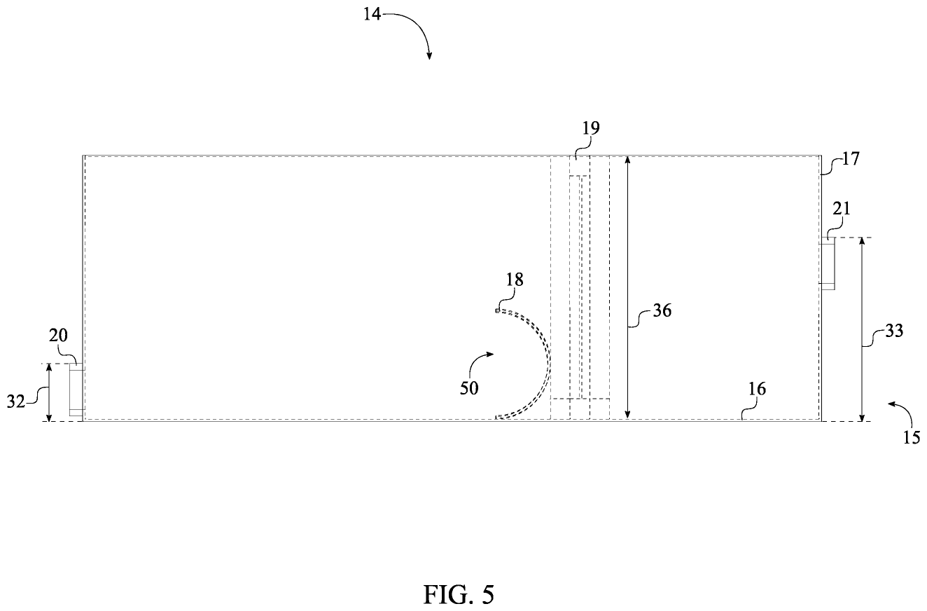

In reference to FIG. 5, the second filtration unit 14 may further comprise at least one second inlet 20 and at least one second outlet 21 in addition to the second debris catcher 18 and the second filter 19. The second inlet 20 is connected to a lateral wall 17 of the second reservoir 15 so that an outlet end of the first hose 29 can be attached to the second reservoir 15. The second outlet 21 is connected to the lateral wall 17 of the second reservoir 15 so that an inlet end of a second hose 30 can be attached to the second reservoir 15. As shown in FIG. 5, the second inlet 20 is positioned adjacent to a base 16 of the second reservoir 15 so that the partially clean water from the first stage of filtration can flow into the bottom of the second reservoir 15. The second outlet 21 is positioned offset from the base 16 of the second reservoir 15 so that the almost clean water from the second stage of filtration can discharge from the top of the second reservoir 15. Furthermore, the second inlet 20 and the second outlet 21 are oppositely positioned of each other about the second reservoir 15 so that the flow direction of the partially clean water can filter through the second debris catcher 18 and the second filter 19. More specifically, the second filter 19 is removably mounted to the base 16 and the lateral wall 17 of the second reservoir 15, wherein the second filter 19 is positioned in between the second inlet 20 and the second outlet 21. The second debris catcher 18 is terminally connected onto the base 16 and the lateral wall 17 of the second reservoir 15, wherein the second debris catcher 18 is positioned in between the second inlet 20 and the second filter 19. When the partially clean water is discharged from the first stage of filtration and flows toward the second outlet 21, the second debris catcher 18 is able to trap remaining heavy particles that sink toward the base 16 of the second reservoir 15. Furthermore, an opened end 50 of the second debris catcher 18 is oriented toward the second inlet 20 to maximize the surface area that comes into contact with the partially dirty water. The partially clean water is then cleaned through the second filter 19 before entering into the second outlet 21 as the almost clean water. As shown in FIG. 5, a second height 32 is defined between the base 16 of the second reservoir 15 to the second inlet 20. A third height 33 is defined between the base 16 of the second reservoir 15 to the second outlet 21. The second outlet 21 enable the second reservoir 15 to maintain a specific water level as the third height is greater than the second height 32. In other words, the water level within the second reservoir 15 is determined by the third height 33. In order to provide proper filtration, a height 36 of the second filter 19 has to be larger than the third height 33 so that partially clean water that flows through the second reservoir 15 is able to fully penetrate through the second filter 19.

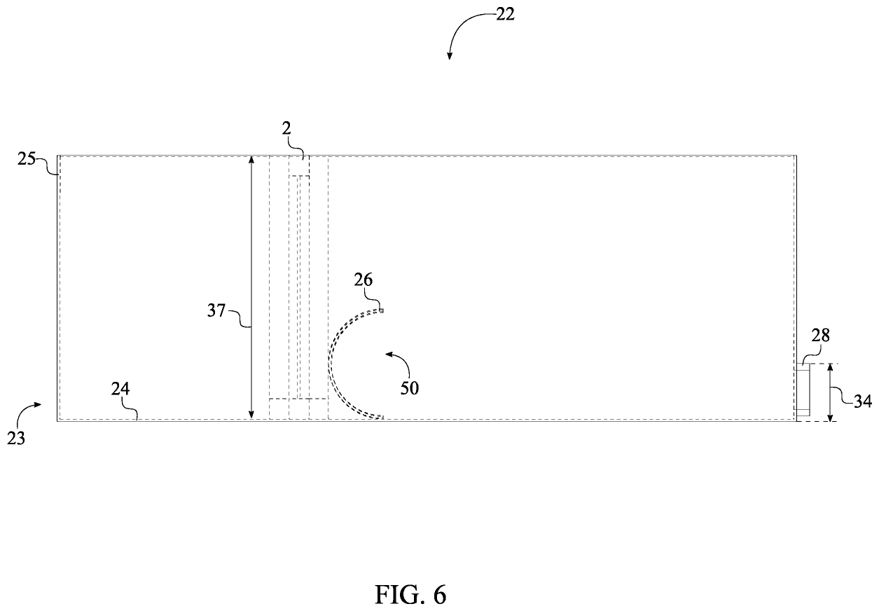

In reference to FIG. 6, the third filtration unit 22 may further comprise at least one third inlet 28 in addition to the third debris catcher 26 and the third filter 27. The third inlet 28 is connected to a lateral wall 25 of the third reservoir 23 so that an outlet end of the second hose 30 can be attached to the third reservoir 23. As shown in FIG. 6, the third inlet 28 is positioned adjacent to a base 24 of the third reservoir 23 in such a way that the submersible pump and the third inlet 28 are oppositely positioned of each other within the third reservoir 23. The third filter 27 is removably mounted to the base 24 and the lateral wall 25 of the third reservoir 23, wherein the third filter 27 is positioned in between the submersible pump and the third inlet 28. The third debris catcher 26 is terminally connected onto the base 24 and the lateral wall 25 of the third reservoir 23, wherein the third debris catcher 26 is positioned in between the third inlet 28 and the third filter 27. When the almost clean water is discharged from the third inlet 28 tank and flows toward the submersible pump, the third debris catcher 26 is able to trap remaining heavy particles that sink toward the base 24 of the third reservoir 23. Furthermore, an opened end 50 of the third debris catcher 26 is oriented toward the third inlet 28 to maximize the surface area that comes into contact with the almost clean water. The almost clean water is then cleaned through the third filter 27 before entering into the submersible pump as the clean water. As shown in FIG. 6, a fourth height 34 is defined between the base 24 of the third reservoir 23 to the third inlet 28 as the water level within the third reservoir 23 is determined by the poisoning and flowrate of the submersible pump. In order to provide proper filtration, a height 37 of the third filter 27 has to be larger than the fourth height 34 so that almost clean water that flows through the third reservoir 23 is able to fully penetrate through the first filter 12.

In reference to FIG. 2, the first hose 29 is terminally attached to the first outlet 13 and the second inlet 20 so that the first reservoir 2 can be in fluid communication with the second reservoir 15 through the first hose 29. More specifically, the inlet end of the first hose 29 is attached to the first outlet 13 and the outlet end of the first hose 29 is attached to the second inlet 20. The second hose 30 is terminally attached to the second outlet 21 and the third inlet 28 so that the second reservoir 15 can be in fluid communication with the third reservoir 23 through the second hose 30. More specifically, the inlet end of the second hose 30 is attached to the second outlet 21 and the outlet end of the second hose 30 is attached to the third inlet 28. The inlet end and the outlet end of the first hose 29 and the second are hermetically attached to the corresponding reservoir to eliminate leakage. Preferably, a quick connected fittings are utilized within each attachment point to easily assemble or disassemble the present invention.

When the present invention is assembled in a flat/level surface area the dirty water from the power sluices flows into the submersible pump due to the positioning of the first outlet 13, the second inlet 20, the second outlet 21, and the third inlet 28. More specifically, the first height 31 is greater than the second height 32 so that the water flows from the first reservoir 2 to the second reservoir 15 due to the gravitational flow. Similarly, the third height 33 is greater than the fourth height 34 so that the water flows from the second reservoir 15 to the third reservoir 23 due to the gravitational flow. When the assembled area is not flat/level, the user can utilize any available supports such as bricks, boulders, logs, or any other supporting base to elevate the corresponding reservoirs to optimize the flow of the dirty water.

Although the invention has been explained in relation to its preferred embodiment, it is to be understood that many other possible modifications and variations can be made without departing from the spirit and scope of the invention as hereinafter claimed.

What is claimed is:

1. A water recirculating system for power sluices comprising:
a first filtration unit;
a second filtration unit;
a third filtration unit;
the first filtration unit comprising a first reservoir, a tailings catcher, a first debris catcher, and a first filter;
the second filtration unit comprising a second reservoir, a second debris catcher, and a second filter;
the third filtration unit comprising a third reservoir, a third debris catcher, and a third filter;
the tailings catcher, the first debris catcher, and the first filter being integrated within the first reservoir;
the second debris catcher and the second filter being integrated within the second reservoir;
the third debris catcher and the third filter being integrated within the third reservoir;
the first reservoir being in fluid communication with the second reservoir; and
the second reservoir being in fluid communication with the third reservoir.

2. The water recirculating system for power sluices as claimed in claim 1 comprising:
the first filtration unit further comprising at least one first outlet;
the tailings catcher being connected to a base of the first reservoir;
the first outlet being connected to a lateral wall of the first reservoir;
the first outlet being positioned offset from the base of the first reservoir;
the tailings catcher and the first outlet being oppositely positioned of each other within the first reservoir;
the first filter being removably mounted to the base and the lateral wall of the first reservoir;
the first filter being positioned in between the tailings catcher and the first outlet;
the first debris catcher being terminally connected onto the base of the first reservoir and the lateral wall of the first reservoir; and
the first debris catcher being positioned in between the tailings catcher and the first filter.

3. The water recirculating system for power sluices as claimed in claim 2, wherein an opened end of the first debris catcher is oriented toward the tailings catcher.

4. The water recirculating system for power sluices as claimed in claim 2 comprising:
a first height;
the first height being defined between the base of the first reservoir to the first outlet; and
a height of the first filter being larger than the first height.

5. The water recirculating system for power sluices as claimed in claim 1 comprising:
the tailings catcher comprising a tubular body, a base panel, a main opening, and a plurality of openings;
a bottom edge of the tubular body being perimetrically connected to the base panel;
the main opening being delineated by a top edge of the tubular body;
the base panel being positioned atop a base of the first reservoir;
the main opening being oppositely positioned from the base of the first reservoir about the tubular body; and
the plurality of openings radially traversing through the tubular body.

6. The water recirculating system for power sluices as claimed in claim 1 comprising:
the second filtration unit further comprising at least one second inlet and at least one second outlet;
the second inlet being connected to a lateral wall of the second reservoir;
the second outlet being connected to the lateral wall of the second reservoir;
the second inlet being positioned adjacent to a base of the second reservoir;
the second outlet being positioned offset from the base of the second reservoir;
the second inlet and the second outlet being oppositely positioned of each other about the second reservoir;
the second filter being removably mounted to the base and the lateral wall of the second reservoir;
the second filter being positioned in between the second inlet and the second outlet;
the second debris catcher being terminally connected onto the base and the lateral wall of the second reservoir; and
the second debris catcher being positioned in between the second inlet and the second filter.

7. The water recirculating system for power sluices as claimed in claim 6, wherein an opened end of the second debris catcher is oriented toward the second inlet.

8. The water recirculating system for power sluices as claimed in claim 6 comprising:
a second height;
a third height;
the second height being defined between the base of the second reservoir to the second inlet;
the third height being defined between the base of the second reservoir to the second outlet;
the third height being greater than the second height; and
a height of the second filter being larger than the third height.

9. The water recirculating system for power sluices as claimed in claim 1 comprising:
the third filtration unit further comprising at least one third inlet;
the third inlet being connected to a lateral wall of the third reservoir;
the third inlet being positioned adjacent to a base of the third reservoir;
the third filter being removably mounted to the base and the lateral wall of the third reservoir;
the third debris catcher being terminally connected onto the base and the lateral wall of the third reservoir; and
the third debris catcher being positioned in between the third filter and the third inlet.

10. The water recirculating system for power sluices as claimed in claim 9, wherein an opened end of the third debris catcher is oriented toward the third inlet.

11. The water recirculating system for power sluices as claimed in claim 9 comprising:
a fourth height;
the fourth height being defined between the base of the third reservoir to the third inlet; and
a height of the third filter being larger than the fourth height.

12. The water recirculating system for power sluices as claimed in claim 1 comprising:
at least one first hose;
at least one second hose;
the first filtration unit further comprising at least one first outlet;
the second filtration unit further comprising at least one second inlet and at least one second outlet;
the first filtration unit further comprising at least one third inlet;
the first hose being terminally attached to the first outlet and the second inlet;
the first reservoir being in fluid communication with the second reservoir through the first hose;
the second hose being terminally attached to the second outlet and the third inlet; and
the second reservoir being in fluid communication with the third reservoir through the second hose.
